(19) United States
(12) Patent Application Publication
(10) Pub. No.: US 2002/0112434 A1
(43) Pub. Date: Aug. 22, 2002

(54) Building block

(76) Inventor: Josef Alexander Eichmann, Wellington (ZA)

Correspondence Address: LARSON & TAYLOR, PLC, 1199 NORTH FAIRFAX STREET, SUITE 900, ALEXANDRIA, VA, 22314, US

(21) Appl. No.: 09/789,494

(22) Filed: Feb. 22, 2001

(51) Int. Cl. E04B 2/32; B28B 7/16

(52) U.S. Cl. 52/592.6; 249/142; 249/160; 52/583.1; 52/605; 52/439

(57) ABSTRACT

A building block for erecting walls, houses or other buildings is provided. The block is made of a special mineral mixture and has at least two relatively parallel channel type hollow spaces passing therethrough. The hollow spaces of the building block are defined by can shaped metal or synthetic plastics profiles. Also a mold with longitudinal and face walls is provided, in particular for producing such a building block. The mold has a frame shaped construction of angle pieces and is arranged on a working plate.

### FIELD OF INVENTION

The present invention relates to a building block for erecting walls, houses or other buildings. Additionally the invention relates to a mould with longitudinal mould walls and face mould walls especially for producing this building block.

### BACKGROUND TO INVENTION

Building blocks made of mineral materials, for example lattice type structures or with through holes, are known. In these blocks the air guiding through holes add to the insulation of a wall constructed by means of the building blocks. Additionally brick machines with mould floors are available, in which such building blocks are formed and which are dried outside thereof.

Being aware of these facts the invention has as object to develop a building block, which can be applied in particular in developing countries, e.g. for earth quake secure constructions, can be used for many different purposes and which also assists in environmental protection. Its production must be very simple and be possible without considerable machine expense.

### SUMMARY OF INVENTION

According to the invention, there is provided a building block for erecting building structures, such as walls, houses and other buildings, the block being made of a suitable mineral mixture and having at least two substantially parallel channel type hollow spaces passing therethrough, the hollow spaces being provided by way of can shaped profiles.

The can shaped profiles are made of metal or of synthetic plastics material.

The building block may be of quadratic shape and may include at least two pairs of hollow can shaped profiles passing through and between two of such pairs of hollow can shaped profiles, and at least one through bore being provided substantially parallel to the hollow can shaped profiles.

The building block may contain two rows of respectively four hollow can shaped profiles arranged distanced apart relatively at about the same central spacing.

The central spacing of the can shaped profiles may correspond to about 1,5 times of a can shaped profile diameter.

At least one of the hollow can shaped profiles may be open at one face side and in use may be arranged to be substantially in alignment with an open hollow profile of a neighbouring building block.

In accordance with the invention the hollow spaces of the building block are defined by can shaped metal or synthetic plastics profiles; empty liquid cans are used—in particular beverage cans—which in this manner are discarded and also provide a contribution for stabilisation of walls and buildings.

In addition it has been found to be favourable to include in a quadratic building block at least four substantially parallel cans as hollow profiles and to arrange parallel thereto through bores between the pairs of hollow profiles; the latter serves for receiving through reinforcement rods, for example of steel wires, and therewith for construction security.

The hollow profile, which is at least open at one face side of the quadratic building block, is arranged, in accordance with the invention, in a wall at least in alignment with one opening hollow profile of a neighbouring building block, i.e. forms throughgoing hollow spaces with this, which allow, for example, temperature insulating air columns to be created.

Further advantages are to be found in the low weight of the building block as well as the effect of a Farraday cage created by the cans. Also the can channels can be applied for guiding reinforcements, for cables and/or for tubes for flow materials, whereby, if necessary, those can channels themself—in sealed off form—can guide flow material.

Also according to the invention, there is provided a mould constructed of longitudinal mould walls and face mould walls, in particular for producing a building block made of a suitable mineral mixture and having at least two substantially parallel channel type hollow spaces passing therethrough, the hollow spaces being provided by way of can shaped profiles, the mould having a frame shaped construction of angle pieces and being located on a working plate.

The mould include at least one drawing rod for tensioning the angle pieces, the drawing rod having an effective length, which is variable by means of a pull strap.

The drawing rod may have a curved end, which passes through the pull strap, the pull strap being to be variably distanced relative to the mould wall.

The pull strap may be arranged at an aperture in a mould wall.

The mould may be covered by a cover plate tensioned at least on one side.

Further according to the invention, there is provided a mould constructed of longitudinal mould walls, face mould walls and a floor plate for producing a building block made of a suitable mineral mixture and having at least two substantially parallel channel type hollow spaces passing therethrough, the hollow spaces being provided by way of can shaped profiles, the mould face walls and longitudinal mould walls being covered by a cover type upper part, as well as a cover plate, which is removably attached to the floor plate.

The floor plate may be arranged to be adjustably spaced relative to the cover plate.

The floor plate may be adjustable by means of a threaded rod.

Disc shaped holders may be provided at the floor and/or the cover plate on the inner side as stops for the hollow can shaped profiles.

Apertures may be provided in the lid and/or floor plate for the hollow can shaped profiles.

At least one drawing rod may be provided for tensioning, the effective length of the drawing rod being variable by way of a pull strap.

The drawing rod may have a curved end which passes through the pull strap, and the latter is arranged to be variably spaced relative to a mould wall.

The pull strap may be arranged at an aperture of a mould wall.

The longitudinal mould walls and/or the face mould walls may be provided with reinforcement profiles.

At least one intermediate mould wall may be provided extending parallel to the face mould walls.

It has been found to be favourable that the curved end of the drawing rod is gripped by the pull strap and that this drawing rod end is arranged to be variably spaced relative to the mould wall. In order to fix this effectively to the pull strap, it is to be fixed to an aperture in the mould wall, into which it is fitted.

The adaptation of the mould to different requirements is, in particular then possible, if the floor plate is arranged to be variably spaced relative to the lid plate, for example can be varied by way of a threaded rod; by rotation of the threaded rod the mould height for the building block can be changed.

It also has been found favourable to provide handles at the floor or lid plate on the inner side in disc form as abutments for the hollow profile or cans whereby, on the other hand, apertures can be provided in the lid and/or floor plate for the hollow profiles or can.

For tensioning the mould the drawing rod is provided with a curved end, the latter passing through the pull strap; due to this the effective length of the drawing rod can be changed.

For increasing the stabilisation the longitudinal walls and/or the face walls can be provided with reinforcement profiles.

The building blocks according to the invention—while in soft state of the production material—may be supplied with additional elements—towel or paper rack for example—by pressing them into the material at one end. Also in accordance with the invention one or another of the building blocks may be positioned in the brickwork in such way that it is possible to grasp through the cans, that means the cans are positioned horizontally and may be used without top or bottom cover on both ends.

Also according to the invention, there is provided a wall constructed of building blocks made of a suitable mineral mixture and having at least two substantially parallel channel type hollow spaces passing therethrough, the hollow spaces being provided by way of can shaped profiles, in which wall additional elements, such as holders, project out of at least one wall face.

Further according to the invention, there is provided a wall constructed of building blocks, each building block being made of a suitable mineral mixture and having at least two substantially parallel channel type hollow spaces passing therethrough, the hollow spaces being provided by way of can shaped profiles, the wall including at least one such building block with horizontally fixed can shaped profiles inside.

Yet further according to the invention, there is provided a wall constructed of building blocks, each block being made of a suitable mineral mixture and having at least two substantially parallel channel type hollow spaces passing therethrough, the hollow spaces being provided by way of can shaped profiles, in which wall at least one wire is pulled through the building blocks for connecting them together.

The wires may be pulled through the hollow spaces of the building blocks.

The building blocks may be tensioned together by means of wires pulled through them.

The wires may be fixed by means of a base part in a foundation.

At least one profile element may be provided on the top of the wall, about which the wires are led.

Apart of the common practice to construct walls with these form or building blocks, in accordance with the invention there is a specially earthquake proofed wall constructions, where the building blocks are connected with wires or the like strings; in accordance with the invention at least one wire or string is pulled through each building block so that both will be tensioned together and/or to other building blocks.

The wire may be anchored with a basis part of the wall foundation and the both vertically uprising part may lead through the cans or the like passages of the building blocks. Furthermore there may be positioned at least one profile element on top of the wall, where the wires or strips will be led around.

### BRIEF DESCRIPTION OF DRAWINGS

The invention will now be described by way of example with reference to the accompanying schematic drawings.

In the drawings there is shown in:

FIG. 1 a plan view of a fist embodiment of a partially cut open mould for producing at least one building block in accordance with the invention;

FIG. 2 a plan view of a second embodiment of a mould in accordance with the invention, the mould being filled with moulding material;

FIG. 3 a cross-section of the mould in FIG. 1 according to the line III-III shown in FIG. 1;

FIG. 4 a longitudinal section through a part of a wall built of building blocks in accordance with the invention;

FIG. 5 a cross-section through another mould in accordance with the invention and being enlarged as compared to FIG. 3;

FIGS. 6, 7 front and side views of a mould lock in accordance with the invention;

FIGS. 8, 10 cut longitudinal sections through a third embodiment of a mould in accordance with the invention;

FIG. 9 a partial inclined view of the mould shown in FIG. 8;

FIG. 11 the front view on a wall built of building blocks in accordance with the invention; and

FIG. 12 a view on another wall built of building blocks in accordance with the invention.

### DETAILED DESCRIPTION OF DRAWINGS

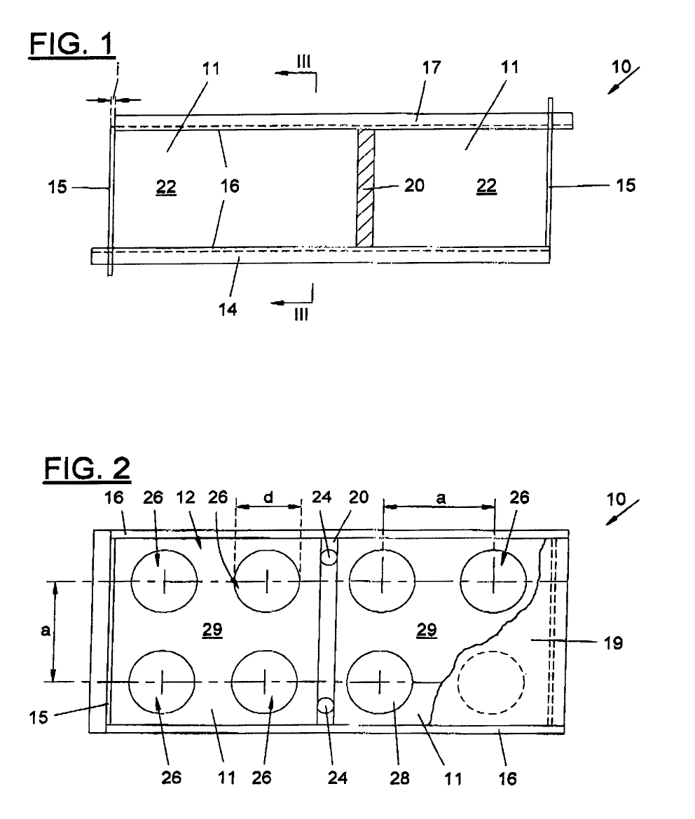

Referring to FIGS. 1 and 2, a frame shaped mould for producing a building block 12 of quadratic form in plan view has two frame parts consisting of angle shaped sheet 14 of for instance steel sheet of a thickness “i” of, for example 1,5 mm, or of an aluminium sheet, which respectively consist of opposite face walls 15 and a longitudinal wall 16 joined thereto, and which, also according to FIG. 2, can be covered by way of a cover plate 19. In the longitudinal centre of the mould 10 of FIGS. 1, 2 an insertable intermediate wall 20 can be seen, which divides the inner space 11 of the mould 10 into two. The mould 10 is placed, for example, on a plate 22 of a working table, which then closes off the mould 10 to below.

In FIG. 2 reference numerals 24 indicates two bores for receiving insertion bolts or of reinforcement profiles or wires 25 (see FIG. 4). Due to the insertion of such reinforcement rods of steel wire or the like a wall construction of such blocks is considerably improved, in particular to be earth quake secure—this being especially then if such a wall is suspended from a steel construction.

In the mould interior 11 on both sides of the intermediate wall 20 respectively four cans 26 of diameter “d” (e.g. 65 mm) are arranged with a centrel spacing “a” of about 100 mm. The cans 26 are embedded in a cement/sand mixture 29 introduced into the mould 10. If the mould 10 is opened, then the building block 12, consisting of—then dried—cement/sand—mixture 29 and the light metal or tin plate cans 26, can be removed.

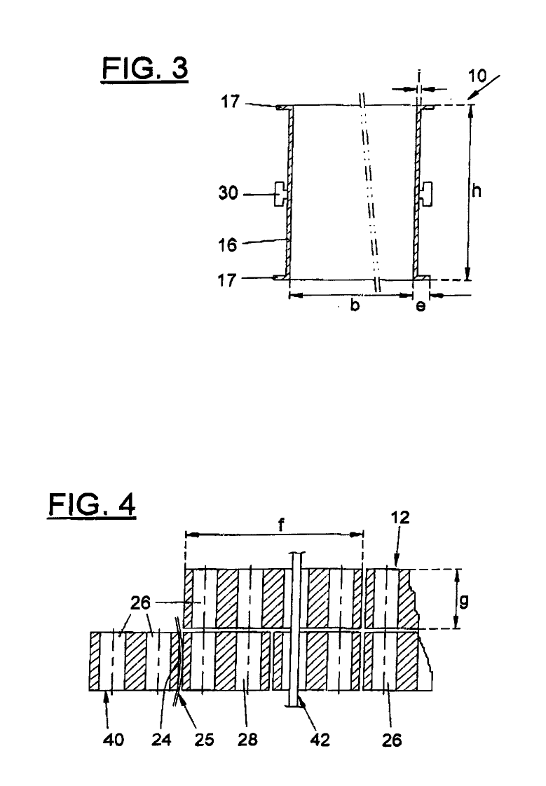

According to FIG. 3 the mould 10 has, for example, a height “h” of 120 mm with an internal diameter “b” of, for example, 200 mm. Collar strips 17 are bent to the outside from the longitudinal walls 16 at the edges. The collar width “e” of the strips 17 measure 20 mm. In half height “h” at parts 30 of a mould lock are indicated.

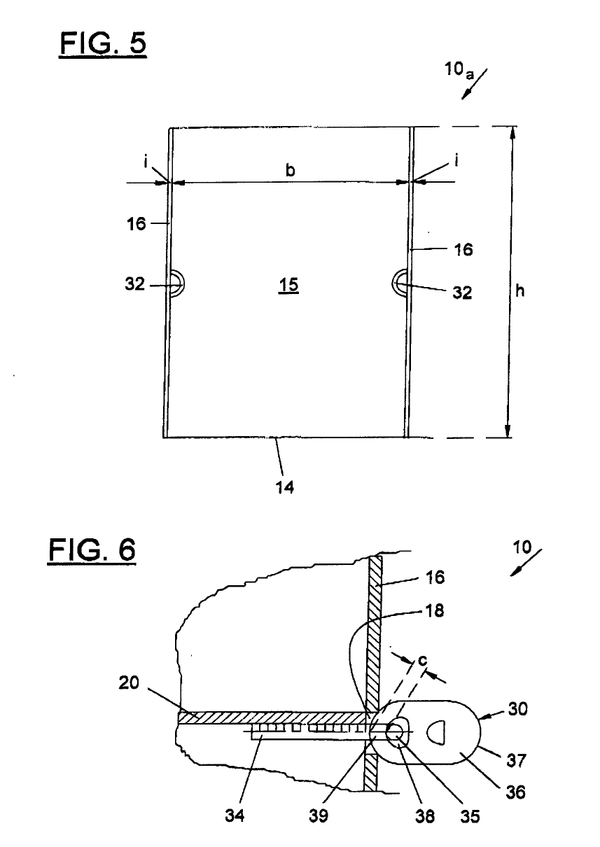

FIG. 5 shows another cross-section through the mould 10 without collar strips 17 and having a wall thickness “i” of 2 mm. Here in half height “h” the longitudinal walls 16 have, for purposes of stabilisation, reinforced profiles 32 in the form of tubes of half cross-section.

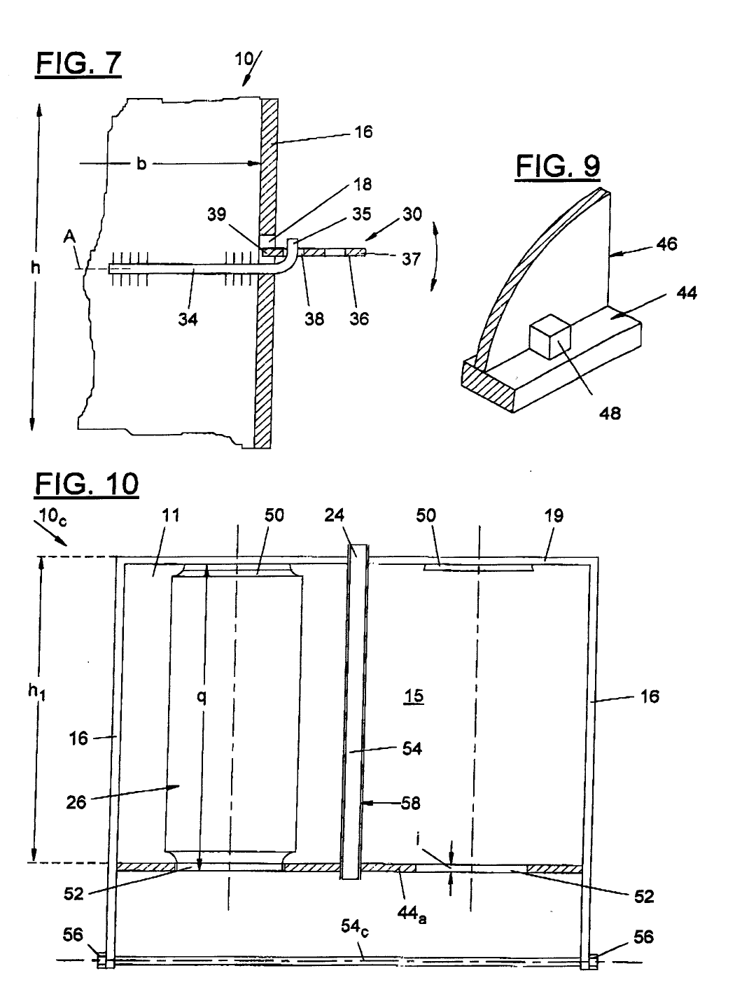

The mould 10—and also the mould 10ₐ of FIG. 5—is, according to FIGS. 6, 7 closable in the region of the intermediate wall 20 by way of a drawing rod 34, which passes through an aperture 18 of the longitudinal wall 16 and engages by way of a curved end 35 in a plate-shaped drawing latch 36 of the mould lock 30; this is provided with a hole 38 for receiving the drawing rod end 35. The width “c” of the pull strap circumference 37 neighbouring on this hole 38 limiting the web 39 measures 2 mm. It is unlocked by tilting the latch 36 from the parallel position to the axis A in the drawing rod 34 shown in FIG. 7.

The resulting mould or building block 12 can be joined together into walls and closures; an example of such a wall 40 is indicated in FIG. 4. Thanks to the cans 26—as hollow profiles without face walls 27—it is possible to join the building blocks 12—for example into a length “f” of about 400 mm as well as a height “g” of 120 mm—easily together, in addition thereby the—for example formed by the empty beverage cans—cans 26 can be sensibly discarded. Further advantages are the low weight of the building block 12, the air columns provided by way of the inner spaces 28 of the cans 26 open on both sides for improving the insulation as well as the effect of the system of the cans 26 as a Faraday cage. It is also possible to use the can channels for guiding cables and/or tubes 42 for flowing material.

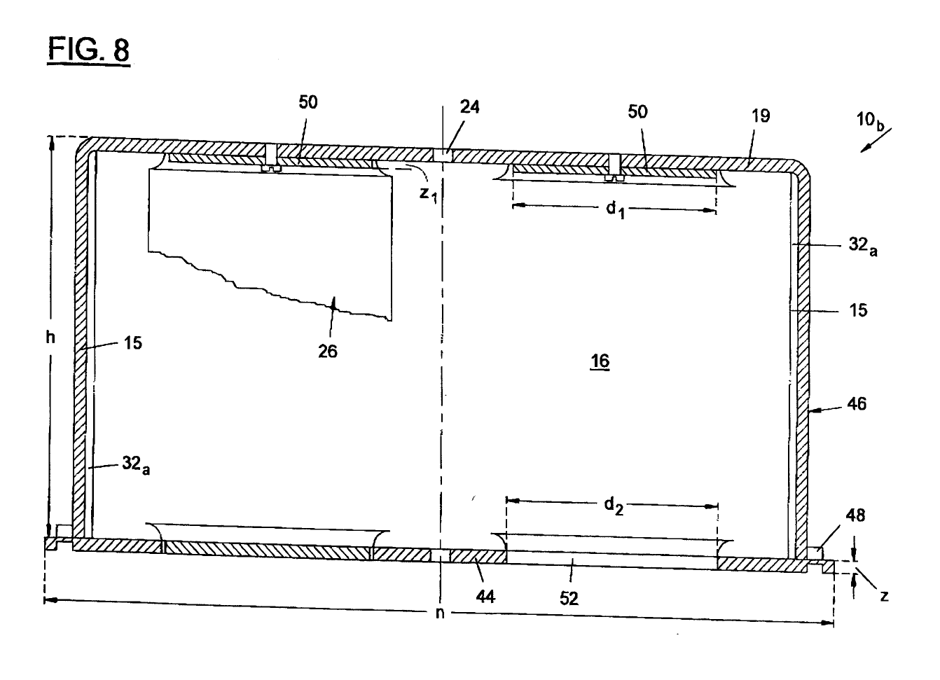

The FIGS. 8 and 9 show a further mould 10_{b}, which preferably can be processed with four cans 26—but also four pairs of cans 26. On one floor plate 44 of the length “n”, being 220 mm and the thickness “z” of 3 mm, a cover type upper part 46 is applied and is screw connected at 48. The upper part 46 contains both face and longitudinal walls 15, 16 as well as a cover plate 19, at which circular discs 50 for fixing the non-illustrated cans 26 are screw connected; their diameters “d₁” measure 57 mm at a plate thickness “z₁” of 3 mm.

Reinforcement rods 32ₐ of half round cross-section extend at the inner faces of the face walls 15.

Opposite to the described discs 50 apertures 52 are provided in the floor plate 44 having a diameter “d₂” of 60 mm. By means of this embodiment the cans 26 can be centered rapidly. Additionally their inner space 28 is kept free of cement/sand/mixture 29.

The inner space 11 of a mould 10_{c} shown in FIG. 10 is, by way of a floor plate 44ₐ, joined to a threaded rod 54, adjustable relative to its height “h₁”, which allows the insertion of cans 26 of different heights “q”. In this embodiment the lower ends of the longitudinal walls 16 are tensioned by threaded rods 54_{c}—cooperating with nuts 56. Reference numeral 58 indicates drinking straws remaining in the building block 12.

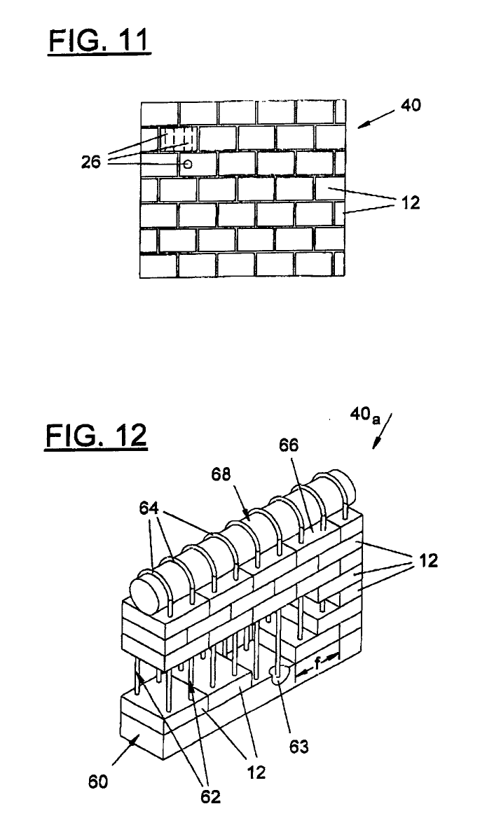

The wall 40, 40ₐ respectively shown in FIGS. 11 and 12 is composed of building blocks 12, which respectively contain two can pairs; about 40 building blocks 12 are required for a square meter wall. On this the acronym GOLE (abbreviation for “gigantic opportunity labour employment”) can be seen in FIG. 11.

FIG. 11 shows in the third row of bricks counted from above the building block 12, which is installed with horizontally fixed cans 26; one of these has no cover on each end, that means top and basic cover are taken off. This allows a grasping hole or peeping hole extending through the wall. The floor and top cover of the can may be replaced with a glass plate or a fly-screen.

The wall 40ₐ shown in FIG. 12 is constructed by way of building blocks 12 of a length of 100 mm on the foundation 60 without connecting mortar filling; at least one string 62—in the example illustrated there being two strings 62—is pulled through each building block 12, which—for example—is led around a tree-trunk or the like profile 68 which is fixed on top of the wall 66 and—forming a wire bow—is led back into a building block 12.

When constructing the foundation 60 the wires or the like strings 62—being concrete reinforcing steel or rod iron—may be installed into the foundation with a basis part 63 and then may be pulled through the connecting passages of the building blocks 12—that means through the cans 26 or the passage bore holes 22. In this way there will be constructed an earthquake secure wired wall 40ₐ, in which the building blocks 12 (as already stated: without any mortar layers) are enclosed.

1. A building block for erecting building structures, such as walls, houses and other buildings, the block being made of a suitable mineral mixture and having at least two substantially parallel channel type hollow spaces passing therethrough, the hollow spaces being provided by way of can shaped profiles.

2. A building block as claimed in claim 1, in which the can shaped profiles are made of metal.

3. A building block as claimed in claim 1, in which the can shaped profiles are made of synthetic plastics material.

4. A building block as claimed in claim 1, which is of quadratic shape and includes at least two pairs of hollow can shaped profiles passing through and between two of such pairs of hollow can shaped profiles, and at least one through bore being provided substantially parallel to the hollow can shaped profiles.

5. A building block as claimed in claim 1, which contains two rows of respectively four hollow can shaped profiles arranged distanced apart relatively at about the same central spacing.

6. A building block as claimed in claim 5, in which the central spacing of the can shaped profiles corresponds to about 1,5 times of a can shaped profile diameter.

7. A building block as claimed in claim 1, in which at least one of the hollow can shaped profiles is open at one face side and in use is arranged to be substantially in alignment with an open hollow profile of a neighbouring building block.

8. A mould constructed of longitudinal mould walls and face mould walls, in particular for producing a building block made of a suitable mineral mixture and having at least two substantially parallel channel type hollow spaces passing therethrough, the hollow spaces being provided by way of can shaped profiles, the mould having a frame shaped construction of angle pieces and being located on a working plate.

9. A mould as claimed in claim 8, which includes at least one drawing rod for tensioning the angle pieces, the drawing rod having an effective length, which is variable by means of a pull strap.

10. A mould as claimed in claim 9, in which the drawing rod has a curved end, which passes through the pull strap, the pull strap being to be variably distanced relative to the mould wall.

11. A mould as claimed in claim 9, in which the pull strap is arranged at an aperture in a mould wall.

12. A mould as claimed in claim 8, which is covered by a cover plate tensioned at least on one side.

13. A mould constructed of longitudinal mould walls, face mould walls and a floor plate for producing a building block made of a suitable mineral mixture and having at least two substantially parallel channel type hollow spaces passing therethrough, the hollow spaces being provided by way of can shaped profiles, the mould face walls and longitudinal mould walls being covered by a cover type upper part, as well as a cover plate, which is removably attached to the floor plate.

14. A mould as claimed in claim 13, in which the floor plate is arranged to be adjustably spaced relative to the cover plate.

15. A mould as claimed in claim 14, in which the floor plate is adjustable by means of a threaded rod.

16. A mould as claimed in claim 13, in which disc shaped holders are provided at the floor and/or the cover plate on the inner side as stops for the hollow can shaped profiles.

17. A mould as claimed in claim 13, in which apertures are provided in the lid and/or floor plate for the hollow can shaped profiles.

18. A mould as claimed in claim 13, in which at least one drawing rod is provided for tensioning, the effective length of the drawing rod being variable by way of a pull strap.

19. A mould as claimed in claim 18, in which the drawing rod has a curved end which passes through the pull strap, and the latter is arranged to be variably spaced relative to a mould wall.

20. A mould as claimed in claim 18, in which the pull strap is arranged at an aperture of a mould wall.

21. A mould as claimed in claim 8, in which the longitudinal mould walls and/or the face mould walls are provided with reinforcement profiles.

22. A mould as claimed in claim 8, in which at least one intermediate mould wall is provided extending parallel to the face mould walls.

23. A wall constructed of building blocks made of a suitable mineral mixture and having at least two substantially parallel channel type hollow spaces passing therethrough, the hollow spaces being provided by way of can shaped profiles, in which wall additional elements, such as holders, project out of at least one wall face.

24. A wall constructed of building blocks, each building block being made of a suitable mineral mixture and having at least two substantially parallel channel type hollow spaces passing therethrough, the hollow spaces being provided by way of can shaped profiles, the wall including at least one such building block with horizontally fixed can shaped profiles inside.

25. A wall constructed of building blocks, each block being made of a suitable mineral mixture and having at least two substantially parallel channel type hollow spaces passing therethrough, the hollow spaces being provided by way of can shaped profiles, in which wall at least one wire is pulled through the building blocks for connecting them together.

26. A wall as claimed in claim 25, in which the wires are pulled through the hollow spaces of the building blocks.

27. A wall as claimed in claim 25, in which the building blocks are tensioned together by means of wires pulled through them.

28. A wall on a foundation as claimed in claim 25, in which the wires are fixed by means of a base part in a foundation.

29. A wall as claimed in claim 25, in which at least one profile element is provided on its top, about which the wires are led.
